(19) United States
(12) Patent Application Publication
(10) Pub. No.: US 2022/0277376 A1
(43) Pub. Date: Sep. 1, 2022

(54) SERVICE DISCOVERY AND DELIVERY THROUGH TRUSTED PARTNERS AND PROVIDERS

(71) Applicant: Aspire to Age, PBC, Austin, TX (US)

(72) Inventors: Shubhada Saxena, Austin, TX (US); Megha Uppal, Austin, TX (US)

(73) Assignee: Aspire to Age, PBC, Austin, TX (US)

(21) Appl. No.: 17/682,967

(22) Filed: Feb. 28, 2022

Related U.S. Application Data
(60) Provisional application No. 63/154,864, filed on Mar. 1, 2021.

(51) Int. Cl. G06Q 30/06; G06Q 20/08

(52) U.S. Cl. CPC G06Q 30/0631; G06Q 20/085

(57) ABSTRACT

The invention generally relates to systems and methods for controlled and monitored referral transfer tracking among a network of trusted service providers. The system allows a request to be sent to one or more organizations that may be able to provide the needed service. The request may be fulfilled by one of these service provider organizations or be forwarded by them to others if they cannot fulfill the request. This chain of forwards and referrals among a network of trusted service providers enable the request to reach across the trusted web of organizations to the one that finally fulfills the requested service. The final provider who delivers the requested service can get paid through the system.

### FIELD OF THE INVENTION

The present disclosure relates to systems and methods for the controlled and monitored transferring of referrals among networks of trusted service providers.

### BACKGROUND OF THE INVENTION

Networking groups designed to refer service requests have been a longstanding way of businesses/service providers to pass service requests of which they have been made aware, but are unable or uninterested in fulfilling, to other services providers that may be in a better position to fulfill such requests. This referral networking system increases a business' ability to provide value to its customers and expands its potential contact network by encouraging reciprocal referrals from the other service providers in its network. Through iterations of referrals both into and out of the business it is able to develop a trust-based relationship between it and the other service providers in its referral networking group.

Online software applications have been used to solve many problems related to the transfer of information between disparate parties. Relatively recently, these online software applications have been used to create social networking systems that are used to connect individuals and businesses across the world, forming virtual networks among groups of individuals and entities having some related interest or connection; however, these online network systems are rarely used to receive, pass, and monitor service referrals between trusted groups of service providers.

Current internet searches, such as those performed through internet search engines such as Google® or Bing®, enable a user to find organizations who provide service and stop there. The user is then in charge of calling or connecting with each of the organizations separately to get the service delivered. Such searching does not leverage the organization's trusted referral network, nor does it provide a means for passing referrals among the organizations network or tracking the request as it is processed and eventually completed.

### BRIEF SUMMARY OF THE INVENTION

The invention generally relates to systems and methods for controlled and monitored referral transfer tracking among a network of trusted service providers.

The system disclosed herein will allow a request to be sent to one or more organizations that claim the provision of the service need. The request can then be fulfilled by one of these service provider organizations or be forwarded by them to others if they cannot fulfill your request. This chain of forwarding and referring can help the request reach across the trusted web of organizations to the one that will actually fulfill the requested service. The final provider who delivers the service can mark that the request as completed when done and get paid.

### BRIEF DESCRIPTION OF THE DRAWINGS

The disclosed subject matter itself, as well as a preferred mode of use, further objectives, and advantages thereof, will best be understood by reference to the following detailed description of an illustrative embodiment when read in conjunction with the accompanying drawings, wherein:

FIG. 1 depicts a network system having a many-to-many mapping that may be processed through the platform.

FIG. 2 depicts a flow diagram illustrating an embodiment of the method in which the system may pass referrals between trusted service providers and connect requesters with end service providers.

FIG. 3 depicts a flow diagram illustrating an embodiment of a method by which the system may receive a service request and pass it to a series of trusted service providers within a network and connect and process transactions between the service requester and the end service provider.

FIG. 4 depicts a flow diagram illustrating an alternate embodiment of a method by which the system may receive a service request and pass it between a series of trusted service providers within a network and connect and process transactions between the service requester and the end service provider, wherein referral payments may be distributed to intermediary referring service providers.

FIG. 5 illustrates, in a block diagram form, a system implementation of the platform used to implement the presented invention and the various components comprising the platform.

### DETAILED DESCRIPTION OF ILLUSTRATIVE EMBODIMENTS

Reference now should be made to the drawings, in which the same reference numbers are used throughout the different figures to designate the same components.

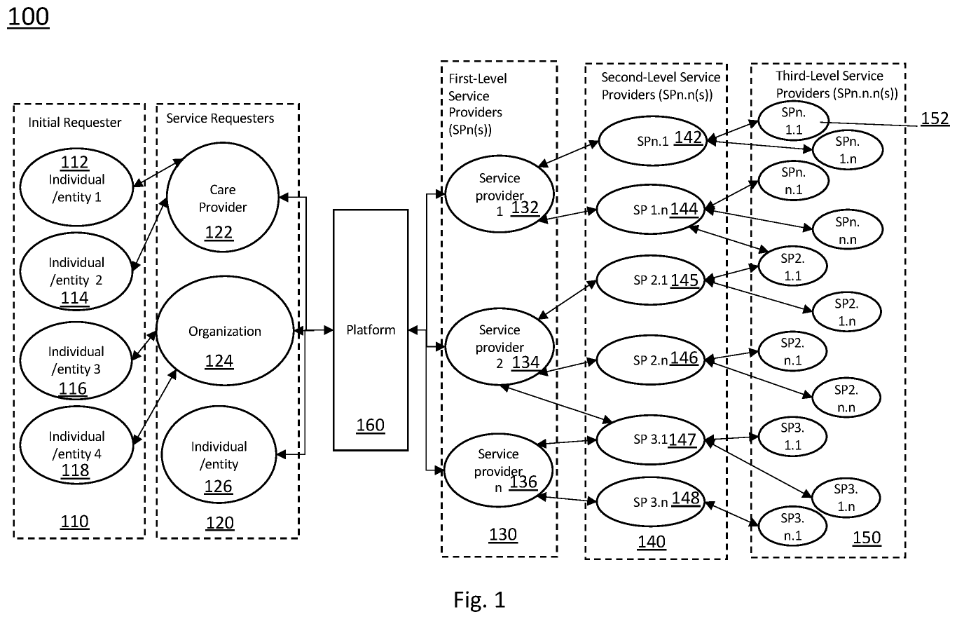

Referring now to FIG. 1, the figure illustrates the various parties in a referral network system 100 to enable discovery of service providers and delivery of requested services through a network of trusted partners and service providers in the referral network system 100. System 100 comprises a pool of requesters 110 comprising many requesters 112, 114, 116, 118 which may be individuals or entities in need of specific services. System 100 further comprises a pool of aggregators or service requesters 120 such as care providers 122, organizations 124, and other individuals or entities 126 that provide aggregation of service procurement for one or more specific services. The aggregators 120 may serve the needs of specific target demographics, such as elderly folks, single parents, people with disability, patients suffering from particular type of ailments such as diabetes, renal issues or cardiac issues among other such ailments. Such service requesters 120 that choose to use referrals to service customer requests may seek services from businesses and service providers 132, 134 or 136 which are members of the pool of service providers 130 and are associated with the platform 160. As an example, the care provider 122 may send a request on behalf of initial requester 112 to the platform 160 to discover and obtain services for a trip to the doctor's office from a service provider for the initial requester 112. The platform 160 may analyze the request and match the request to a first level service provider 132 in a pool of such first level service providers 130. If the service provider 132 is unable to, or otherwise do not wish to, fulfil the service request it may submit a request to the platform to pass the service request as a referral to one or more other service providers with which the business has some prior association such as service providers 142 in a pool of second-level service providers 140. These trusted service providers may either accept the service request or pass it as a referral to one or more of the service providers in their trusted network pool of third-level service providers 150, such as 152. The request at each level may be made to multiple service providers in that pool such as pool 150 of trusted service providers by multiple service providers form the higher-level pool of service providers such as pool 140. This process of passing service request referrals through the platform may be iterated until a service provider accepts the service request, at which point the platform may connect the end service provider with the service requester 122 which may connect such service provider to the initial requester 112.

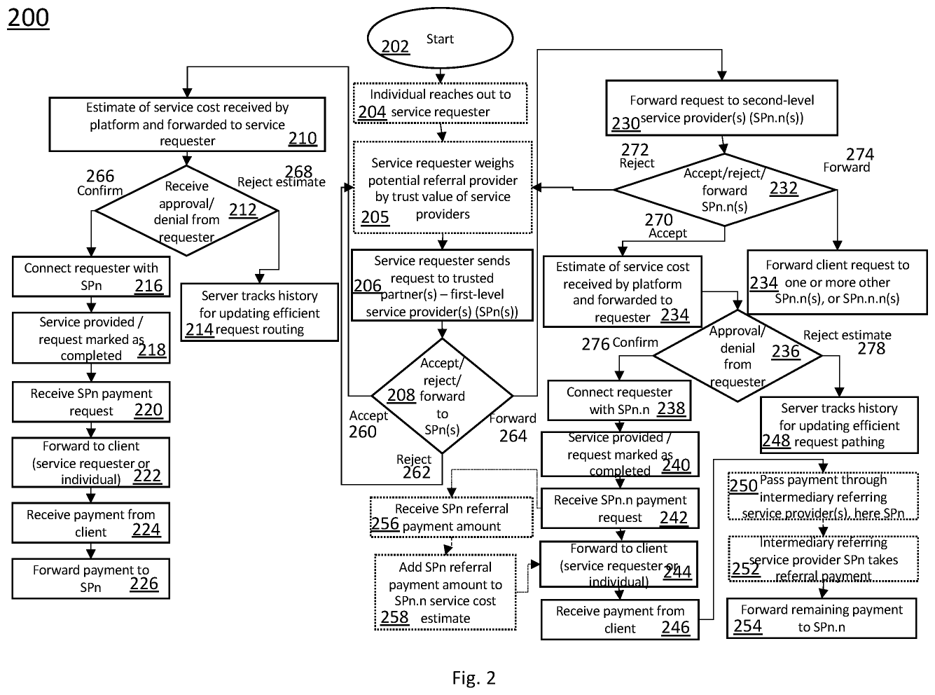

FIG. 2 illustrates a process flow diagram for how the system and the platform may pass service requests and referrals among the networks of trusted service providers. Referring to FIG. 2, the process starts at 202 with an initial requester from the pool of initial requester (110 depicted in FIG. 1) determines the need for some service. At step 204 the initial requester 110 may reach out with a service request to a service requester in the pool of service requesters (120 depicted in FIG. 1). At step 205, the service requester may perform an optional weighing step in which they assign weights to the various members of their trusted referral network by a trust value associated with each of service providers in their trusted network to prioritize the service providers whom they trust most for the type of service request being sought. The service requester may then transmit the service request at step 206 to one or more of the first-level trusted service providers in their pool of first-level service providers 130 (SP1-SPn) (collectively “SPn(s)”), through the platform. In certain embodiments, the initial requester may bypass the steps 205 and 206 and directly make the request to a first level service provider. In other embodiments, the service requester may designate one or more first-level service providers SPn(s) to which their service request is initially transmitted. At step 208, the one or more SPn(s) may then accept 260 the service request, reject 262 the service request, or forward 264 the service request to one or more of the service providers in their own trusted network, the second-level service provider pool 140 (SPn.1 -SPn.n(s) (collectively “SPn.n(s)” or “second level service providers”)).

If the SPn rejects 262 the service request, the platform may then send the request back to the service requester at step 228 so that the service requester may reconsider its referral of the service request and possibly choose alternate service providers to service the request.

If the SPn accepts 260 the service request, that SPn may submit an estimate of the service cost to the platform at step 210, which may forward that service cost estimate to the requester. Once the service requester receives the service cost estimate from the platform they may either confirm 266 or reject 268 the estimate. If the service requester rejects 268 the service cost estimate the platform may receive the rejection and store a token related to the rejection of the service cost estimate for later use in updating the platform's routing of service requests to improve its efficiency at step 214. If the service requester confirms 266 the service cost estimate, the platform may connect the service requester with the SPn that provided the estimate at step 216. After the service requester and SPn have been connected the platform may mark the request as fulfilled/complete at step 218. The platform may also receive a payment request from SPn at step 220 and forward that payment request to the service requester at step 222. Once the service requester has received the payment request form SP1, the service requester may submit payment to the platform at step 224. Once the platform receives the payment from the service requester it may forward the payment to the SPn at step 226.

If the SPn chooses to forward 264 the service request the platform may receive this decision and forward the service request to one or more of SPn's trusted service providers in the pool of second-level service provider(s) (SPn.n(s)) at step 230. One or more of the SPn.n(s) may receive and then accept 270, reject 272, or forward 274 the service request referral at step 232.

If the SPn.n rejects 272 the service request referral, the platform may then send the request back to the service requester at step 228 so that the service requester may reconsider its referral of the service request and possibly choose alternate service providers to service the request.

If the SPn.n accepts 270 the service request referral then that SPn.n may submit an estimate of the service cost to the platform at step 234, which may forward that service cost estimate to the service requester. Once the service requester receives the service cost estimate from the platform, they may either confirm 276 or reject 278 the estimate. If the service requester rejects 278 the service cost estimate the platform may receive the rejection and store a token related to the rejection of the service cost estimate for later use in updating the platform's routing of service requests to improve its efficiency at step 248.

If the requester confirms 276 the service cost estimate, the platform may connect the service requester with the SPn.n that provided the estimate at step 238. After the requester and SPn.n have been connected the platform may mark the request as fulfilled/complete at step 240. The platform may also receive a payment request from SPn.n at step 242. The platform may forward that payment request to the service requester at step 244. Once the service requester has received the payment request form SP1, the service requester may submit payment to the platform at step 246. Once the platform receives the payment from the service requester it may forward the payment to the SPn.n at step 254.

If, certain embodiments, the service request is being passed between multiple levels of trusted service providers in the form of a service request referral passed through the platform, several optional steps related to the providing of a service cost estimate and to the submission of payment may be performed. Included in these optional steps are that the platform may receive a referral payment amount from one or more intermediary referring service providers (in this example SPn) through which the service requester's service request had been passed before being accepted by the SPn.n end service provider. The platform may add the one or more referral payment amount(s) to the service cost estimate submitted by the end service provider (here SPn.n) to generate and provide an updated service cost estimate to the service requester. If such referral payment amount(s) is/are added to the service cost estimate, the payment, once submitted to the platform, may divided into the cost for the service submitted by the end service provider and the referral payment(s) submitted by each of the intermediary referring service providers and doled out by the platform to each party as required. Alternatively, the platform may pass the payment to each of the intermediary referring service provider(s) that that they may each receive their referral payment amount from the payment in sequence, with the remaining amount provided to the end service provider.

The embodiment discussed above is illustrated in FIG. 2 where the platform may further receive a referral payment request from SPn at step 256. The platform may add the SPn referral payment amount to the SPn.n payment amount at step 258 and forward that payment request to the service requester at step 244. In this embodiment, the platform after receiving payment from service requester at step 246, may pass the payment through intermediary referring service provider SPn at step 250, where the intermediary referring service provider SPn collects the referral payment at step 252 and then forward the remaining payment to the SPn.n at step 254.

If the SPn.n elects to forward the service request to one or more of their own network of trusted service providers, steps illustrated in this method may be iterated through subsequent levels of networks of trusted service providers until an end service provider accepts the service request and the service requester confirms said end service provider's service cost estimate, including the additional amounts for referral payments if such referral payments are being applied to the transaction.

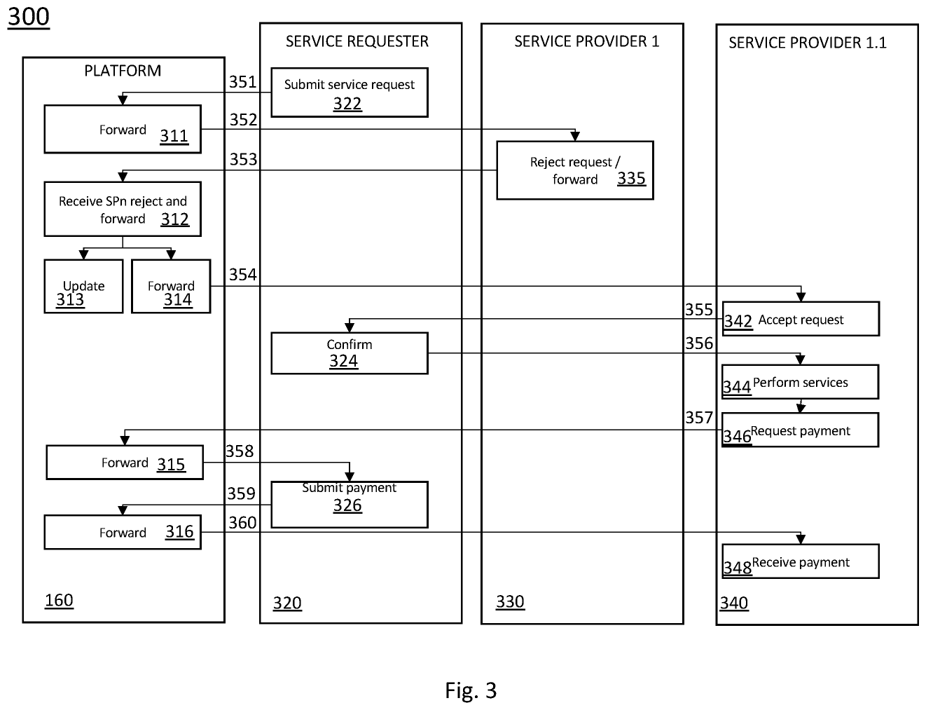

submit a portion of the payment, in the form of a referral payment, to any intermediary referring service provider(s), in this illustrated embodiment, the first level service provider 330, before the Referring now to FIG. 3, it illustrates in a different way the flow diagram that illustrates an exemplary method in which the platform and system may operate to monitor and pass referrals among networks of trusted service providers where a first-level service provider rejects the request to better explain the communication flow between the levels of service providers and the platform. In the illustrated embodiment, a service requester 320 associated with the platform 160 may receive a request from an initial requester. The service requester may send the request 322 to the platform 160 through a message 351. The platform 160 may then forward 311 the request to a first-level trusted service provider 330 through a message 352. Service Provider 330 may reject 335 the request and request the platform 160 to forward the request to a second-level service provider 340 in their trusted network. The response 312 from service provider 330 may be received by the platform 160 via message 353. If the platform 160 determines that the request was rejected by service provider 330, the platform 160 may use that information to update 313 the manner by which it routes referrals in the future.

If the platform 160 determines that service provider 330 requested a forward to a trusted second-level service provider 340, who has a trusted relationship with the first-level service provider 330, the platform 160 may then forward 314 the request to the second-level trusted service provider 340 via message 354. The second-level trusted service provider 340, may then receive the service request. If second-level service provider 340 accepts the service request a request 355 to confirm 324 the services may be transmitted to the service requester 320. In certain embodiments, second-level service provider 340 may additionally send a token to the platform 160, which the platform 160 may use to monitor the transaction between second-level service provider 340 and the service requester 320, and/or update its referral passing mechanics. If the service requester confirms second-level service provider's 340 acceptance of the service request it may send a confirmation 356 to second-level service provider 340. Upon receipt of the service requester's confirmation, second-level service provider 340 may perform 344 the services. Upon completion of the services, or at some other reasonable time, second-level service provider 340, as the final service provider, may request payment 346, which may be sent to the platform 160 through a request 357. The platform 160 may then forward 315 the payment request from second-level service provider 340 to the service requester 320 via payment request 358. The service requester may then remit payment 326 to the platform 160 through transaction 359. The platform 160 may then forward 316 the payment to the second-level service provider 340 by means of transaction 360. The second-level service provider 340 receives payment 348 through transaction 360.

In certain embodiments, platform 160 may remit a referral payment to first-level service provider 330 and the remainder of the payment to the second-level service provider 340 (referral payment not depicted in FIG. 3).

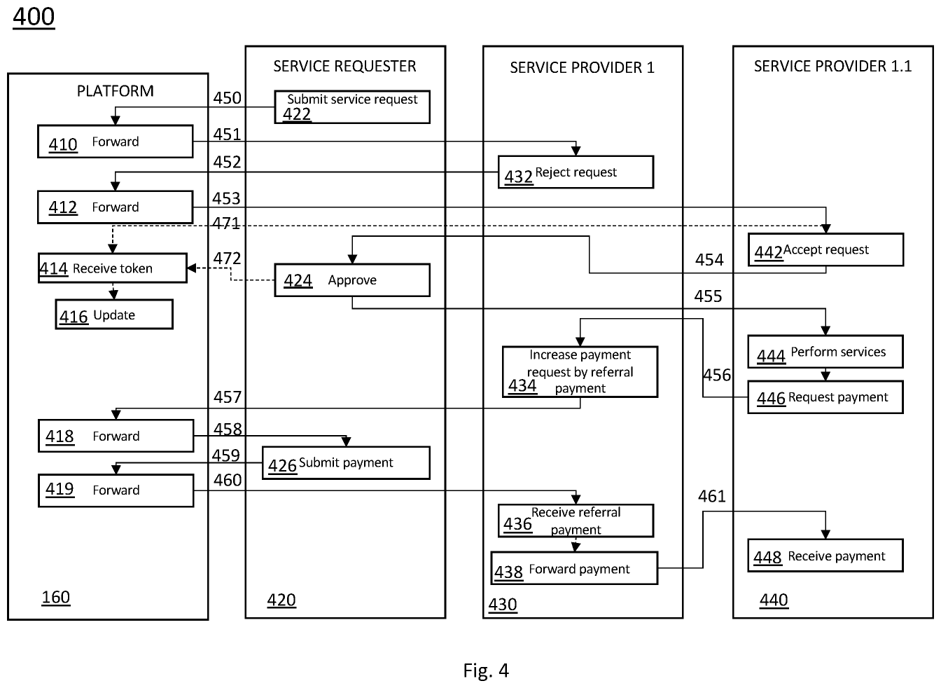

FIG. 4 illustrates another embodiment in which the platform 160 may operate to monitor and pass referrals among networks of trusted service providers. The embodiment depicted in FIG. 4 illustrates optional steps shown in dashed lines for both receiving response tokens based on actions taken by service providers that the platform 160 may use to update its referral processing mechanisms and for inclusion and distribution of referral payments into service cost estimate provided to the service requester. Furthermore, the tokens maybe used for making referral payment from the payment remitted by the service requester to the intermediary referring service provider before the remainder of the payment is sent to the end service provider.

In the illustrated embodiment of FIG. 4, a service requester 420 associated with the platform 160 may receive a request from an initial requester. The service requester may send the request 422 to the platform 160 through a message 450. The platform 160 may then forward 410 the request to a first-level trusted service provider 430 through a message 451. Service Provider 430 may reject 432 the request through message 452.

If the platform 160 determines that service provider 430 rejected the request, the platform 160 may then forward 412 the request to the second-level trusted service provider 440 via message 453. The second-level trusted service provider 440, may then accept 442 the received request. If second-level service provider 440 accepts the service request it may send a message to approve 424 the services for the estimated cost which may be transmitted to the service requester using message 454. In the illustrated embodiment in FIG. 4, second-level service provider 440 may additionally send a token to the platform 160. Platform 160 may receive token 414 and use it to update 416 its referral passing mechanics.

If the service requester approves 424 second-level service provider's 440 acceptance of the service request it may send a confirmation 555 to second-level service provider 440. The service requester may also send a token to platform 160 through message 472 which may be used by the platform 160 to monitor the transaction between second-level service provider 440 and the service requester 420, and/or update 416 its referral passing mechanics.

Upon receipt of the service requester's approval, second-level service provider 440 may perform 444 the services. Upon completion of the services, or at some other reasonable time, second-level service provider 440, as the final service provider, may request payment 446, which may be sent to the first-level service provider 430 through request 456. The first-level service provider 430 may increase 434 the requested payment from second-level service provider platform and send the request for the aggregate payment to platform 160 through request 457. Platform 160 may then forward 418 the payment request from first-level service provider 430 to the service requester 420 by submitting payment 426 via payment request 458. The service requester may then remit payment to the platform 160 through transaction 459. The platform 160 may then forward 419 the payment to the first-level service provider 430 by means of transaction 460. The first-level service provider 430 receives referral payment 336 and forwards 438 remaining payment via transaction 461 to second-level service provider 440 which receives payment 448 towards the services provided.

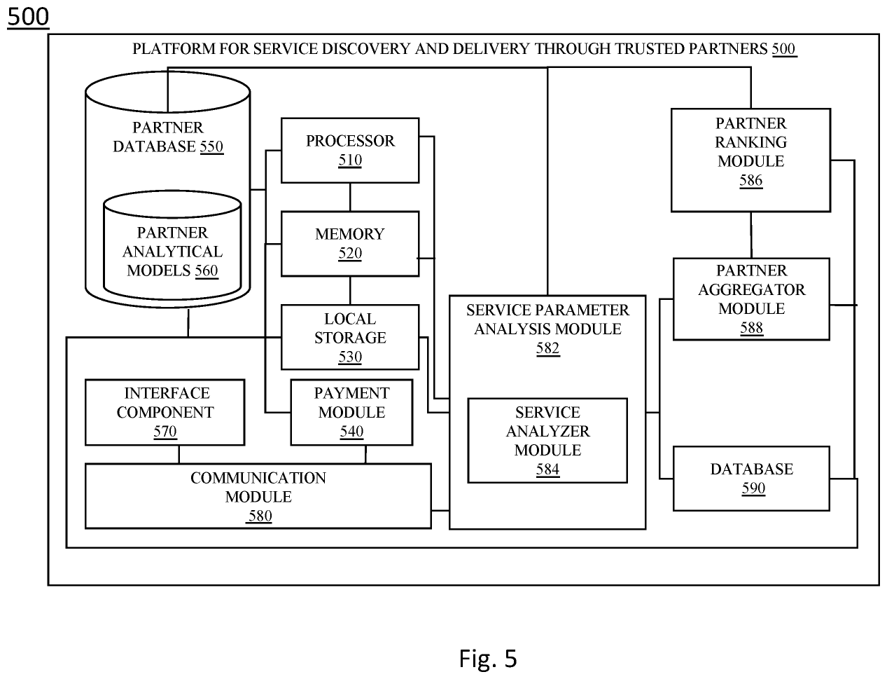

FIG. 5 illustrates in block diagram form an embodiment of a platform 500 and the various elements of the platform.

Referring to FIG. 5, the platform comprises of a processor 510 that can executive instructions and process data related to the requested services and the various services providers that interface with the platform 500. The processor 510 is connected to a processor memory 520 used to execute instructions as well as data related to the algorithms and instructions being executed by the processor. The platform in the illustrated embodiment also comprises a local storage 530 to store information relevant to the requested services and the various services providers along with the service requesters utilizing the platform to discover those desired services and use the platform to facilitate the delivery of such services.

Platform 500 further comprises a partner database 550 of service providers. In certain embodiments, this database may contain the relevant information about the level-one service providers, whereas in other embodiments this database my contain information about lower-level service providers as well. Database 550 may be updated as new information about service providers is obtained through referrals from other service providers as well as when a new service provider joins the network for use of the platform to provider the desired services to service requesters. Partner database 550 may further comprise partner analytical models 560 that may contain analytical models to be used to identify a service provider to service a request from a service requester by utilizing the saved information for various service providers that may be ranked or assigned weights based on feedback from service requesters, past experience of a particular service provider accepting, rejecting or forwarding a service request, cost of services, types of services provided by service provider, geographic areas services by service providers, the referral network of a service provider, information provided by the service provider, and such other parameters.

Platform 500 further comprises a payment module 540 that is responsible for obtaining the cost associated with a requested service from a service provider and completing the transaction by receiving the payment from the service requester and make the appropriate payments to the service provider. In certain embodiments, the payment module 540 may also calculate the referral payments to intermediary service providers that forwarded the request for service to a lower-level service provider in their network of trusted service providers. In other embodiments, the payment module may receive an aggregated payment request from the service provider including the referral amount along with the cost of service delivered by the service provider that accepted the request for service on the platform.

Platform 500 also comprises the communication module 580 that facilitates the communication between the service requester and the service providers at different level of hierarchy of service providers. Platform 500 further includes the interface component 570 that facilitates the dissemination of relevant information to the service requester as well as service providers. In embodiments, such interface component 570 may provide interfaces to connect to mobile devices, connections established over the internet, pre-arranged web pages, a dedicated application to be used on a mobile device or a computer, interfaces to smart devices available to the service requester such as Amazon Alexa, Google Home, Apple watch, an IoT device and similar other smart devices.

The illustrated embodiment of the platform 500 in FIG. 5 also comprises a partner ranking module 586 that uses information available about a service provider, historical experience with a particular service provider as well as feedback and ratings from service requesters to rank or assign a weight to a service provider. This information may be stored in the partner database 550 and used to update the partner analytical models 560. Partner ranking module 586 may also analyze the ranking of the various service providers to propose the most efficient routing of a service request to the appropriate service provider.

In an alternate implementation, service parameter analysis module 582 may be used to analyze the requested service through the use of service analyzer module 584 to identify a subset of service providers that are appropriate or capable of providing the requested service. The platform 500 may also contain a partner aggregator module 588, that may be used to build the service provider library over time by means of receiving the relevant information from service providers using the platform or/and by utilizing the relevant information of a service provider that was referred the service request from a service provider already ion the platform through a forward of a service request.

In some embodiments the partner aggregator module 588 may include support for messaging a referred service provider to join the platform.

In embodiments, the inclusion of referral payment amounts into the service cost estimate and payment of such referral payment amounts by the payment module 540 from the payment remitted by the service requester may be iterated for any number of intermediary referring service providers.

In embodiments, the platform may forward the referral to a different first-level trusted service provider 134 (SP2, as depicted in FIG. 1) in place of, or in addition to forwarding the referral to one or more second-level trusted service provider(s).

In embodiments, a service requester may be a care provider, a service providing business, an organization, or an individual or other entity. In embodiments, the service requester may be the end recipient of the service being requested (i.e. an initial requester).

In embodiments, the service requester may designate the one or more first-level service providers (SPn(s)) to which the service request is initially sent.

In embodiments, the platform or one or more service providers in the referral chain may use service provider response information to update trust values between associated service providers. In such embodiments the initial requester may also be the service requester.

In embodiments, the system may associate one or more graphemes to a service request. Such graphemes may be used to identify the service request by any of a multitude of characteristics in order to enable the system to categorize service requests. The categorization of the service requests through use of the graphemes may be used in conjunction with a feedback and updating procedure within the system in order to tune the system by using its previous transaction history in order to increase its efficiency.

In embodiments, the system may associate one or more graphemes to service providers. Such graphemes may be related to the services that the service provider claims to provide or has historically provided through the system.

The graphemes associated with services and/or service providers may provide for search indexing of the services and service providers such that a service requester may be able to use the system to search for service providers who claim to, or have historically provided, services consistent with, or related to, the services for which the service requester is seeking.

In embodiments, the system may implement protocols such as HTTP or HTTPS in conjunction with graphemes to allow for indexing and searching of services and service providers. Such protocols may also be used for collection of data, including metrics, associated with the provision of services or other transactions through the platform.

In embodiments, the system may comprise a feedback and updating procedure. Such a feedback procedure may comprise receiving a kickback notification responsive to a particular service provider not accepting a service request and/or forwarding the service request to one or more of their network of trusted service providers. The system may use this kickback notifications to update its mechanism for routing similar types of service requests to improve the routing efficiency of service requests of that type. For example, such a feedback system may enable the system to reduce the probability a particular type of service request may be initially forwarded to a service provider who has historically not accepted service requests of that type. In other embodiments, the feedback and updating procedure that the system uses may comprise using a kickback notification responsive to an end service provider successfully completing and closing out a service request. In embodiments using a feedback and updating procedure the system may “bubble up” successful paths for the routing of similar service requests and/or may “bubble down” paths that have been historically unsuccessful for similar services.

In embodiments, the system may utilize netAI: Network Augmented Intelligence (NAI) in the development or management of the trusted network of service providers. In embodiments, the system may utilize webAI: Web Augmented Intelligence (WAI) in the development or management of the trusted network of service providers.

In embodiments, the system may comprise a simple user interface that locks down the functionality of the hardware on which the system is running in order to limit the hardware such that it may only provide for relatively basic operations that are consistent with the operation of the system.

In embodiments, the system may comprise a hypertext search protocol. The hypertext search protocol may be used to search for hypermarked services. In embodiments, the hypermarking of the services may be effectuated through usage of graphemes.

In embodiments, the system may comprise a trust weighting mechanism. The trust weighting mechanism may use information related to past referral transactions to increase or decrease the weighting of a trust value assigned between a service provider and a member of its trusted network, or between a service requester and a service provider. In embodiments of the system the value of the trust value may be used to affect the referral pathing through the system. In other embodiments of the system the value of the trust value may impact the manner in which the associated service provider is presented to the parties with which they are related in the system.

In embodiments, in determination of the services being provided or supported by the system may consider the eight degrees of integration for the quality of life which include Community and Health Services, Transportation, Housing, Social Participation, Civic Participation and Employment, Active Living and Outside Areas, Communication and Education, and Food, or the eight dimensions of wellness, namely the Emotional, Spiritual, Intellectual, Physical, Environmental, Financial, Occupational, and Social needs of a person.

In embodiments, a payment submitted by a requester may pass through one or more referring service providers before it reaches the end service provider. In such embodiments each of the one or more intermediary referring service providers may receive a portion of the payment for having been responsible for passing the service request to the end service provider. Such a payment portion distributed to intermediary referring service providers may be a percentage of the estimated service cost submitted by the end service provider, a percentage of the actual service cost paid by the requester, a flat amount established contractually between the intermediary service provider and the end service provider or other downstream intermediary referring service provider, or an amount established by any other known means. This amount will be generally referred to herein as a referral payment.

In embodiments of the system in which intermediary referring service provider may take a referral payment for passing a service request to one or more of their trusted referral partners the system and method of its operation may additionally comprise steps wherein the service estimate provided by a service provider (including the service estimate provided by the end service provider) may be passed through the one or more intermediary referring service providers who may each add a referral payment amount to the estimate. In such embodiments when the service estimate reaches the requester the service estimate consists of the sum of the original service estimate plus the sum of the referral payment amounts for each of the intermediary referring service providers through which the requester's request was passed before reaching the service provider who tendered the original service estimate.

In embodiments, the system may deconstruct a single service request into a plurality of sub-requests which may be independently transferred among one or more networks of trusted service providers, through the platform, and may be performed by one or more independent service providers. Such embodiments may be beneficial for service requests where a single service provider may not be able to fulfill all elements of the service request. An example of such a request may a request for delivery of groceries containing special items like ingredients for ethnic dishes, which may only be available from certain providers. In such embodiments, the system may divide the transaction into multiple transactions each with an associated cost and then aggregate and compile the costs for the sub-requests to present it to the requester as a single cost estimate.

What is claimed is:

1. A method of service delivery comprising the steps of:
receiving a service request from a service requester;
sending the service request to a first-level trusted service provider;
receiving a response comprising one of an acceptance along with an estimate, a rejection and a request to forward the service request to a second-level trusted service provider;
taking one of the following actions based on the received response:
sending the estimate received with the acceptance to the service requester;
finding a second first-level trusted service provider as a result of receiving the rejection response; and
sending the service request to a second-level trusted service provider as a result of receiving the request to forward the service request to a second-level trusted service provider.

2. The method of claim 1, wherein after receiving a service request the method steps are repeated until receiving a response comprising the acceptance along with an estimate.

3. The method of claim 2, wherein the trusted service providers are classified in multitude of levels from first-level to n-level.

4. Method of claim 2 further comprising the steps of:
receiving approval from the service requester of the received estimate with the acceptance;
connecting the service requester with the service provider from whom the response comprising the acceptance along with an estimate was received;
marking the service request complete;
receiving a payment request from the service provider from whom the response comprising the acceptance along with an estimate was received;
forwarding to the service requester the payment request;
receiving a payment from the service requester;
forwarding payment to the service provider from whom the response comprising the acceptance along with an estimate was received.

5. Method of claim 2, further comprising the step of adding a referral payment for the first-level service provider if the response comprising the acceptance along with an estimate came from a second-level service provider.

6. Method of claim 2, further comprising the steps of:
recording the received responses from the first-level trusted service providers;
utilizing the recorded received responses to assign a weight to the trusted service providers; and
using the assigned weight to determine the recipients of the service requests.

7. Method of claim 2, wherein the received response from a service provider further comprises a token to be used for assigning a weight to the service provider.

8. Method of claim 2, wherein the estimate received with the acceptance from the service provider includes a referral payment for the service provider at a higher level than the service provider that accepted the service request.

9. Method of claim 2, wherein the forwarded payment is delivered through a chain of service providers.

10. A system for discovery and delivery of services comprising:
a processor capable of executing a set of instructions stored in a memory;
a service requester in need of a service;
a database of a set of service providers;
an analysis module to identify a service provider capable of providing the service;
a communication interface to communicate with the service provider and the service requester;
a payment module to facilitate a payment for the service from the service requester to the service provider;

11. The system of claim 10, wherein the database of a set of service providers includes weightages assigned to the service providers in the set of service providers.

12. The system of claim 10, wherein the payment for the service includes a referral payment to a referring service provider.

13. The system of claim 10, wherein the set of service providers comprises the service providers grouped in subsets by a priority level.

14. The system of claim 10, further wherein the system further comprises a partner aggregator module, wherein the partner aggregator module provides a recommendation to add a new service provider to the database of a set of service providers.
